(19) United States
(12) Patent Application Publication
(10) Pub. No.: US 2014/0189246 A1
(43) Pub. Date: Jul. 3, 2014

(54) MEASURING APPLICATIONS LOADED IN SECURE ENCLAVES AT RUNTIME

(71) Applicants: Bin Xing, Hillsboro, OR (US); Matthew E. Hoekstra, Forest Grove, OR (US); Michael A. Goldsmith, Lake Oswego, OR (US); Carlos V. Rozas, Portland, OR (US); Vincent R. Scarlata, Beaverton, OR (US); Simon P. Johnson, Beaverton, OR (US); Uday R. Savagaonkar, Portland, OR (US); Francis X. Mckeen, Portland, OR (US); Stephen J. Tolopka, Hillsboro, OR (US)

(72) Inventors: Bin Xing, Hillsboro, OR (US); Matthew E. Hoekstra, Forest Grove, OR (US); Michael A. Goldsmith, Lake Oswego, OR (US); Carlos V. Rozas, Portland, OR (US); Vincent R. Scarlata, Beaverton, OR (US); Simon P. Johnson, Beaverton, OR (US); Uday R. Savagaonkar, Portland, OR (US); Francis X. Mckeen, Portland, OR (US); Stephen J. Tolopka, Hillsboro, OR (US)

(21) Appl. No.: 13/731,439

(22) Filed: Dec. 31, 2012

(51) Int. Cl. G06F 12/14; G06F 12/08

(52) U.S. Cl. CPC G06F 12/14; G06F 12/0891
USPC 711/135; 711/163

(57) ABSTRACT

Embodiments of an invention for measuring applications loaded in secure enclaves at runtime are disclosed. In one embodiment, a processor includes an instruction unit and an execution unit. The instruction unit is to receive an instruction to extend a first measurement of a secure enclave with a second measurement. The execution unit is to execute the instruction after initialization of the secure enclave.

### BACKGROUND

1. Field

The present disclosure pertains to the field of information processing, and more particularly, to the field of security in information processing systems.

2. Description of Related Art

Confidential information is stored, transmitted, and used by many information processing systems. Therefore, techniques have been developed to provide for the secure handling and storing of confidential information. These techniques include various approaches to creating and maintaining a secured, protected, or isolated partition or environment within an information processing system.

### BRIEF DESCRIPTION OF THE FIGURES

The present invention is illustrated by way of example and not limitation in the accompanying figures.

FIG. 1 illustrates a system including measuring applications loaded in secure enclaves at runtime according to an embodiment of the present invention.

FIG. 2 illustrates a secure enclave unit according to an embodiment of the present invention.

FIG. 3 illustrates a system architecture according to an embodiment of the present invention.

FIGS. 4 and 5 illustrate methods for measuring an application loaded in a secure enclave at runtime according to an embodiment of the present invention.

### DETAILED DESCRIPTION

Embodiments of an invention for measuring applications loaded in secure enclaves at runtime are described. In this description, numerous specific details, such as component and system configurations, may be set forth in order to provide a more thorough understanding of the present invention. It will be appreciated, however, by one skilled in the art, that the invention may be practiced without such specific details. Additionally, some well-known structures, circuits, and other features have not been shown in detail, to avoid unnecessarily obscuring the present invention.

In the following description, references to “one embodiment,” “an embodiment,” “example embodiment,” “various embodiments,” etc., indicate that the embodiment(s) of the invention so described may include particular features, structures, or characteristics, but more than one embodiment may and not every embodiment necessarily does include the particular features, structures, or characteristics. Further, some embodiments may have some, all, or none of the features described for other embodiments.

As used in the claims, unless otherwise specified the use of the ordinal adjectives “first,” “second,” “third,” etc. to describe an element merely indicate that a particular instance of an element or different instances of like elements are being referred to, and is not intended to imply that the elements so described must be in a particular sequence, either temporally, spatially, in ranking, or in any other manner.

Also, the terms “bits,” “flags,” “fields,” “entries,” etc., may be used to describe any type of storage location in a register, table, database, or other data structure, whether implemented in hardware or software, but are not meant to limit embodiments of the invention to any particular type of storage location or number of bits or other elements within any particular storage location. The term “clear” may be used to indicate storing or otherwise causing the logical value of zero to be stored in a storage location, and the term “set” may be used to indicate storing or otherwise causing the logical value of one, all ones, or some other specified value to be stored in a storage location; however, these terms are not meant to limit embodiments of the present invention to any particular logical convention, as any logical convention may be used within embodiments of the present invention.

As described in the background section, various approaches to creating and maintaining a secured, protected, or isolated partition or environment within an information processing system have been developed. One such approach involves secure enclaves as described in the co-pending U.S. patent application entitled “Method and Apparatus to Provide Secure Application Execution,” filed Jun. 19, 2012, Ser. No. 13/527,547, which is hereby incorporated by reference as an example of at least one embodiment of a secure enclave. However, the incorporated reference is not intended to limit the scope of embodiments of the invention in any way and other embodiments may be used while remaining within the spirit and scope of the invention.

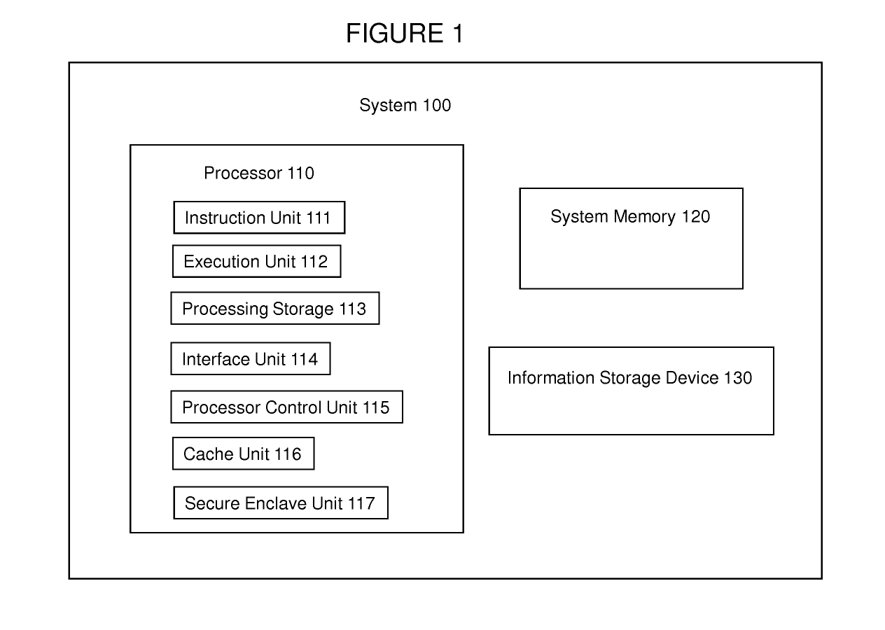

FIG. 1 illustrates system 100, an information processing system including measuring applications loaded in secure enclaves at runtime according to an embodiment of the present invention. System 100 may represent any type of information processing system, such as a server, a desktop computer, a portable computer, a set-top box, a hand-held device, or an embedded control system. System 100 includes processor 110, system memory 120, and information storage device 130. Systems embodying the present invention may include any number of each of these components and any other components or other elements, such as information storage devices, peripherals, and input/output devices. Any or all of the components or other elements in this or any system embodiment, may be connected, coupled, or otherwise in communication with each other through any number of buses, point-to-point, or other wired or wireless interfaces or connections, unless specified otherwise.

System memory 120 may be dynamic random access memory or any other type of medium readable by processor 110. Information storage device 130 may include any type of persistent or non-volatile memory or storage, such as a flash memory and/or a solid state, magnetic, or optical disk drive.

Processor 110 may represent one or more processors integrated on a single substrate or packaged within a single package, each of which may include multiple threads and/or multiple execution cores, in any combination. Each processor represented as processor 110 may be any type of processor, including a general purpose microprocessor, such as a processor in the Intel® Core® Processor Family, Intel® Atom® Processor Family, or other processor family from Intel® Corporation, or another processor from another company, or a special purpose processor or microcontroller. Processor 110 may include instruction unit 111, execution unit 112, processing storage 113, interface unit 114, processor control unit 115, cache unit 116, and secure enclave unit 117. Processor 110 may also include any other circuitry, structures, or logic not shown in FIG. 1, and/or any circuitry, structures, or logic shown or described as elsewhere in FIG. 1.

Instruction unit 111 may represent any circuitry, structure, or other hardware, such as an instruction decoder, for fetching, receiving, decoding, and/or scheduling instructions. Any instruction format may be used within the scope of the present invention; for example, an instruction may include an opcode and one or more operands, where the opcode may be decoded into one or more micro-instructions or micro-operations for execution by execution unit 112.

Execution unit 112 may include any circuitry, structure, or other hardware, such as an arithmetic unit, logic unit, floating point unit, shifter, etc., for processing data and executing instructions, micro-instructions, and/or micro-operations.

Processing storage 113 may represent any type of storage usable for any purpose within processor 110; for example, it may include any number of data registers, instruction registers, status registers, configuration registers, control registers, other programmable or hard-coded registers or register files, or any other storage structures.

Interface unit 114 may represent any circuitry, structure, or other hardware, such as a bus unit, messaging unit, or any other unit, port, or interface, to allow processor 110 to communicate with other components in system 100 through any type of bus, point to point, or other connection, directly or through any other component, such as a memory controller or a bus bridge.

Processor control unit 115 may include any logic, microcode, circuitry, or other hardware to control the operation of the units and other elements of processor 110 and the transfer of data within, into, and out of processor 110. Processor control unit 115 may cause processor 110 to perform or participate in the performance of method embodiments of the present invention, such as the method embodiments described below, for example, by causing processor 110 to execute instructions received by instruction unit 111 and micro-instructions or micro-operations derived from instructions received by instruction unit 111.

Cache unit 116 may represent any one or more levels of cache memory in a memory hierarchy of information processing system 100, implemented in static random access memory or any other memory technology. Cache unit 116 may include any combination of cache memories dedicated to or shared among any one or more execution cores or processors within processor 110 according to any known approaches to caching in information processing systems.

Secure enclave unit 117 may represent any logic, circuitry, hardware, or other structures for creating and maintaining a secured, protected, or isolated environment, such as a secure enclave as described herein, in which an application or other software may run, execute, be loaded, or otherwise be present within an information processing system such as system 100. For purposes of this description, each instance of such an environment may be referred to as a secure enclave, although embodiments of the present invention are not limited to those using a secure enclave as the secured, protected, or isolated environment. In one embodiment, a secure enclave may be created and maintained using instructions in the instruction set of a processor in the Intel® Core® Processor Family or other processor family from Intel® Corporation.

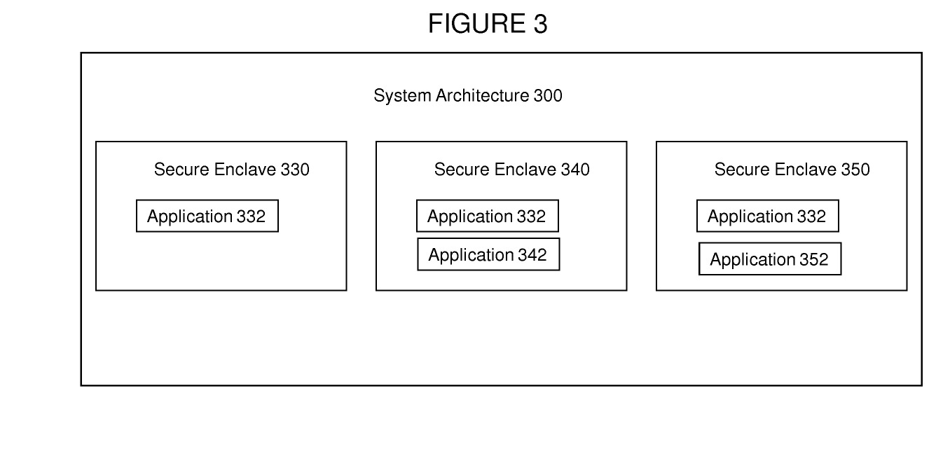

FIG. 3 illustrates secure enclave unit 300, an embodiment of which may serve as secure enclave unit 117 in system 100. All or part of secure enclave unit 300 may be included within any one or more other units of processor 110, such as instruction unit 111, execution unit 112, processor storage 113, processor control unit 115, and cache unit 116.

Secure enclave unit 200 may include encryption unit 210, which may include any logic, circuitry, or other hardware to execute any one or more encryption algorithms and the corresponding decryption algorithms, and may include logic, circuitry, or other hardware shared with another encryption unit in processor 110.

Secure enclave unit 200 may also include enclave page cache (EPC) 220. In one embodiment, EPC 220 may be a dedicated portion of cache unit 116, such as a portion of a last level cache. Other embodiments are possible, including embodiments in which all or part of EPC 220 may be outside of processor 110. EPC 220 may be used to store unencrypted code and data for one or more secure enclaves. Access control logic 214, range register(s) 216, and EPC map (EPCM) 218 may be used to prevent access to a page within EPC 220 except by an application running on processor 110 within the secure enclave to which the page is allocated.

Embodiments of the present invention provide for a measuring an application in a secure enclave. An application may include any software, program, code, routine, module, instructions, executable, object, file, data structure, data, etc. that may be loaded into a secure enclave. Measuring an application may include calculating, generating, or deriving a cryptographic hash or other value based on the content, amount of memory (e.g., EPC pages), relative location of each page, and/or any other attributes of an application whether loaded into an enclave or not. A measurement may be based on code or other information within an application and/or a public key or other information used to sign or otherwise attest to the identity or integrity of an application. The measurement may be used to derive one or more cryptographic keys to encrypt information for the enclave, to seal information to the enclave, and/or to verify or attest to the identity of an application. Embodiments of the present invention provide for measuring an application when a secure enclave is initialized and again during execution of an application within the enclave, so that a new measurement may be provided after an application has been dynamically modified, by, for example, but not limited to, the addition or loading of dynamically loaded or linked library files, Java classes, native or encrypted code, etc. (each of which may itself be considered an application).

To illustrate, FIG. 3 shows system architecture 300, in which secure enclaves 330, 340, and 350 have been created. Each of secure enclaves 330, 340, and 350 has been initialized with application 332. In this embodiment, application 332 may be a loader, interpreter, or other program or application that may be modified by the addition or loading of other application code and/or data. For example, secure enclave 340 has been modified by the loading of application 342 after initialization, and secure enclave 350 has been modified by the loading of application 352 after initialization.

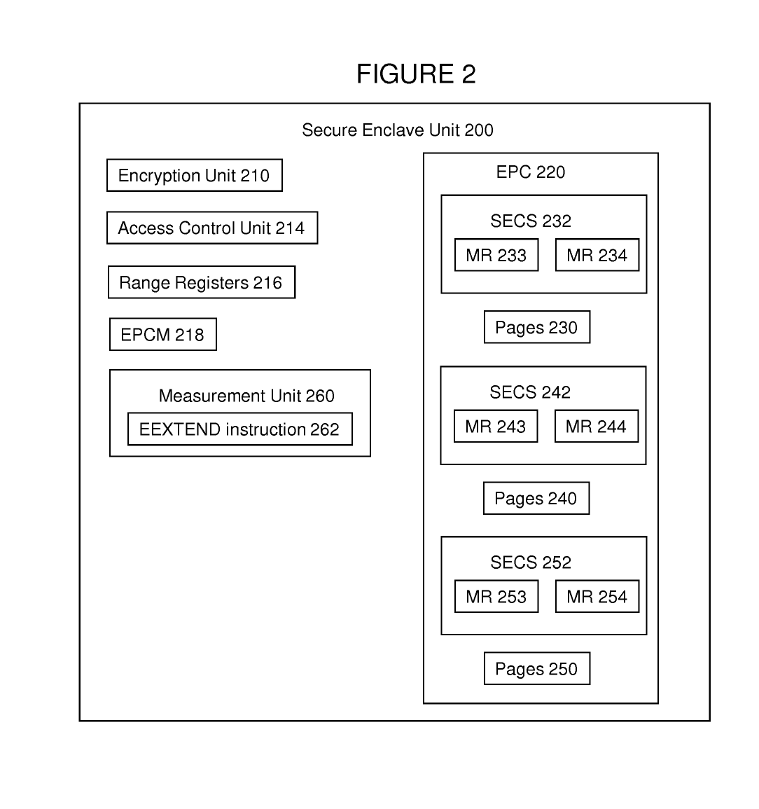

Returning to FIG. 2, EPC 220 may include any number of pages for any number of different enclaves. For each enclave, one or more pages may be allocated to store a secure enclave control structure (an SECS), created, for example, using an ECREATE instruction. For example, SECS 232 may be created for secure enclave 330, SECS 242 may be created for secure enclave 340, and SECS 252 may be created for secure enclave 350. An SECS may include one or more fields of any size (e.g., 256 or 512 bits) to serve as a measurement register (MR) to store a measurement of code and/or data associated with a secure enclave and/or an application or applications loaded into a secure enclave. For example, MRs 233 and 234 may be used for secure enclave 330, MRs 243 and 244 may be used for secure enclaves 340, and MRs 253 and 254 may be used for secure enclaves 350.

Pages in EPC 220 may be allocated to an enclave, for example by using an EADD instruction. For example, page(s) 230 may be allocated to secure enclave 330, page(s) 240 may be allocated to secure enclave 340, and page(s) 250 may be allocated to secure enclave 350. Each time a page is added to a secure enclave, a measurement of that secure enclave stored in a measurement register for the secure enclave may be extended with the measurement of the new page, for example, the new measurement may be calculated as a hash of the concatenation of the old measurement and a measurement of the new page, and the new measurement may replace the value of the old measurement in the measurement register.

Secure enclave unit 200 may also include measurement unit 260. Measurement unit 260 may include any logic, circuitry, or other hardware to provide for measuring applications, code, and/or data according to embodiments of the present invention, including circuitry to implement a secure hash algorithm such as SHA-256 or SHA-512. Measurement unit 260 may also include microcode, logic, circuitry, and/or other hardware to decode and execute an EEXTEND instruction 262.

EEXTEND instruction 262 may be used by an operating system or other software to measure an application, code/and or data loaded or to be loaded in a secure enclave. Parameters, which may be implicit or specified as direct operands, indirect operands, or using any other approach, for EEXTEND instruction 262, may include a first measurement and a second measurement. In one embodiment, the first measurement is a measurement of an enclave generated at initialization (e.g., a measurement of enclave 340 as initialized with application 332), and the second measurement is a measurement of an application to be loaded into the enclave after initialization (e.g., application 342). The first measurement may be the result of a measurement performed and extended each time a new page is added (e.g., using EADD) to an enclave prior to initialization (e.g. using EINIT), and may be stored in a measurement register for the enclave (e.g., MR 243). The second measurement may be a measurement of the application (e.g., application 342) itself or of a public key used to sign the application. Furthermore, the second measurement may be stored in a different measurement register for the same enclave (e.g., MR 244) in an architecture in which two MRs are available for EEXTEND instruction 262, or may be calculated by the application (e.g., application 332) already loaded in the enclave (e.g., enclave 340) before any instructions from the new application (e.g., application 342) are executed.

Execution of EEXTEND instruction 262 extends the first measurement with the second measurement to generate a third measurement. For example, the third measurement is a hash of the concatenation of the first measurement and the second measurement (in that order). The third measurement represents the enclave with both applications loaded (e.g., enclave 340 with applications 332 and 342 loaded) and is different from the measurement of an enclave with just the initially loaded application (e.g., enclave 330 with application 332 loaded) and is different from the measurement of an enclave with a different application loaded after initialization (e.g., enclave 350 with applications 332 and 352 loaded). Therefore, the third measurement may be used to generate one or more keys, for example by using an EGETKEY instruction, that are specific to the enclave as it is configured or otherwise exists at runtime. The third measurement may be stored in a measurement register, for example, replacing the measurement in the measurement register in which the first or the second measurement was stored. Accordingly, EEXTEND instruction 262 may be used repeatedly for the same enclave to dynamically extend the measurement of the enclave each time a new application is loaded.

Therefore, embodiments of the present invention may be used to provide for generating measurements for an enclave as it is dynamically reconfigured, for example, by loading an executable file after the enclave has been initialized. The measurement is specific to the enclave as it exists at runtime, so the enclave cannot use the measurement to impersonate a different enclave, including another enclave that was initialized with the same application, and a different enclave cannot impersonate it or decrypt its secrets. For example, each of enclaves 340, 350, and 360 will have a different measurement, even though each was initialized with the same application (application 332). Therefore, each enclave will be able to attest to its own identity to a verifier, such as an independent software vendor or a content provider, as a condition for the verifier to release a decryption key or other restricted information to an enclave. Also, none of the enclaves will be able to decrypt information encrypted using a key derived from a different enclave's measurement.

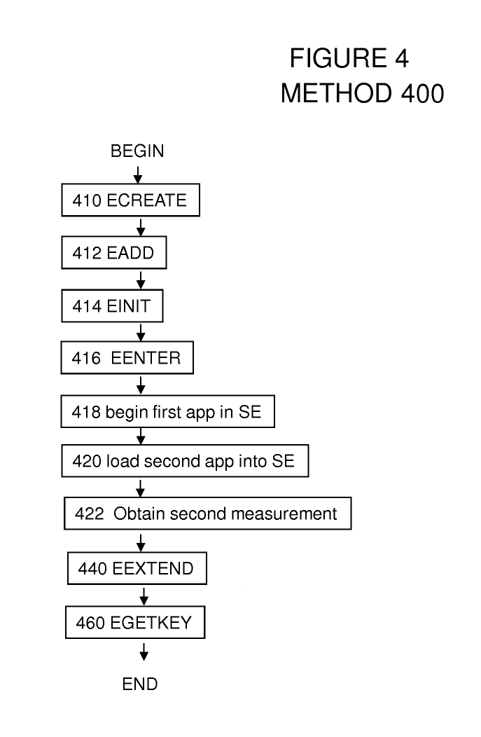

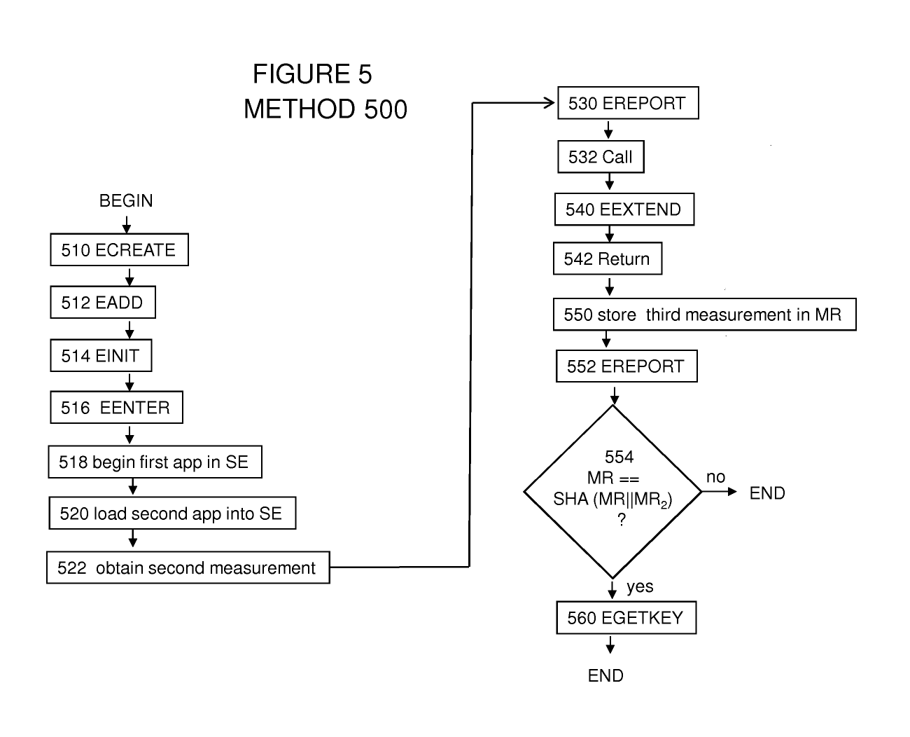

FIGS. 4 and 5 illustrate methods 400 and 500 for measuring an application loaded in a secure enclave at runtime according to an embodiment of the present invention. In method 400, an EEXTEND instruction may be executed by an application running in a secure enclave. In method 500, EEXTEND is a privileged instruction that is executed by software (e.g., an operating system) running outside of a secure enclave. Although method embodiments of the invention are not limited in this respect, reference may be made to elements of FIGS. 1, 2, and 3 to help describe the method embodiment of FIG. 4.

In box 410 of FIG. 4, creation of a secure enclave (e.g., enclave 340) may begin, for example, by an operating system using an ECREATE instruction, resulting in the creation of an SECS (e.g., SECS 242) for an enclave (e.g., enclave 340). In box 412, pages (e.g., pages 240) in EPC 220 may be allocated to the secure enclave, for example, by the operating system using an EADD instruction. These pages may be pages storing or to store a first application (e.g., application 332). Each time a page is added in box 412, a measurement of the enclave, stored in a first measurement register (e.g., MR 243), is extended with the measurement of the new page.

In box 414, the secure enclave may be initiated, for example by the operating system using an EINIT instruction. The measurement of the enclave at the time of initiation, e.g. when the EINIT instruction is executed, referred to as the first measurement, may be stored in a first measurement register (e.g., MR 243) after having been generated and extended as described above. In box 416, execution of the first application (e.g., application 332) may enter the secure enclave, for example by using an EENTER instruction. In box 418, execution of the first application in the secure enclave may begin.

In box 420, the first application may load a second application (e.g., application 342) into the secure enclave. In box 422, a measurement of the second application, referred to as the second measurement, may be generated or obtained, for example, by the first application calculating a measurement of the pages added in box 420 or reading the public key used to sign the second application. In one embodiment, the second measurement may be stored in a second measurement register (e.g., MR 244).

In box 440, an EEXTEND instruction (e.g., EEXTEND instruction 262) is executed from within the secure enclave, for example by the first application, extending the first measurement with the second measurement to generate a third measurement. In one embodiment, the third measurement may be stored in the first measurement register, replacing the first measurement. In another embodiment, the third measurement may be stored in the second measurement register, replacing the second measurement. Note, however, that in an embodiment having a first and a second measurement register used as described above, the contents of the first register should not be used for a key generation (e.g., by an EGETKEY instruction) because the first measurement might remain in the first register even after the enclave has been dynamically modified, which might allow an enclave modified after initialization to impersonate an enclave unmodified after initialization.

In box 460, the third measurement may be used to derive a key to represent the secure enclave as dynamically reconfigured at run time, for example using an EGETKEY instruction.

In box 510 of FIG. 5, creation of a secure enclave (e.g., enclave 340) may begin, for example, by an operating system using an ECREATE instruction, resulting in the creation of an SECS (e.g., SECS 242) for an enclave (e.g., enclave 340). In box 512, pages (e.g., pages 240) in EPC 220 may be allocated to the secure enclave, for example, by the operating system using an EADD instruction. These pages may be pages storing or to store a first application (e.g., application 332). Each time a page is added in box 512, a measurement of the enclave, stored in a first measurement register (e.g., MR 243), is extended with the measurement of the new page.

In box 514, the secure enclave may be initiated, for example by the operating system using an EINIT instruction. The measurement of the enclave at the time of initiation, e.g. when the EINIT instruction is executed, referred to as the first measurement, may be stored in a first measurement register (e.g., MR 243) after having been generated and extended as described above. In box 516, execution of the first application (e.g., application 332) may enter the secure enclave, for example by using an EENTER instruction. In box 518, execution of the first application in the secure enclave may begin.

In box 520, the first application may load a second application (e.g., application 342) into the secure enclave. In box 522, a measurement of the second application, referred to as the second measurement, may be generated or obtained, for example, by the first application calculating a measurement of the pages added in box 520 or reading the public key used to sign the second application. In one embodiment, the second measurement may be stored in a second measurement register (e.g., MR 244).

In box 530, the secure enclave generates and stores a first report of its identity (e.g., using an EREPORT instruction), to be used later to verify that the first measurement has been extended by the second measurement. In box 532, the secure enclave may call privileged code, such as a secure enclave driver in operating system kernel code, running outside the enclave, to execute the EEXTEND instruction.

In box 540, an EEXTEND instruction (e.g., EEXTEND instruction 262) is executed from outside of the secure enclave, for example by a secure enclave driver in operating system kernel code, extending the first measurement with the second measurement to generate a third measurement. In box 542, the privileged code outside the secure enclave returns the third measurement to the secure enclave.

In box 550, the secure enclave stores the third measurement in a measurement register. In one embodiment, the third measurement may be stored in the first measurement register, replacing the first measurement. In another embodiment, the third measurement may be stored in the second measurement register, replacing the second measurement. Note, however, that in an embodiment having a first and a second measurement register used as described above, the contents of the first register should not be used for a key generation (e.g., by an EGETKEY instruction) because the first measurement might remain in the first register even after the enclave has been dynamically modified, which might allow an enclave modified after initialization to impersonate an enclave unmodified after initialization.

In box 552, the secure enclave generates and stores a second report of its identity (e.g., using an EREPORT instruction). In box 554, the secure enclave uses the results of the first and second reports to determine whether the first measurement has been extended by the second measurement, for example by checking that the contents of the measurement register of the measurement register into which the third measurement has been stored has been extended with the second measurement. If not, then method 500 may end after signaling an error, fault, or other such condition. If so, then method 500 continues in box 560.

In box 560, the third measurement may be used to derive a key to represent the secure enclave as dynamically reconfigured at run time, for example using an EGETKEY instruction.

In various embodiments of the present invention, the methods illustrated in FIGS. 4 and 5 may be performed in a different order, with illustrated boxes combined or omitted, with additional boxes added, or with a combination of reordered, combined, omitted, or additional boxes. Furthermore, many other method embodiments are possible within the scope of the present invention.

Embodiments or portions of embodiments of the present invention, as described above, may be stored on any form of a machine-readable medium. For example, all or part of methods 400 and 500 may be embodied in software or firmware instructions that are stored on a medium readable by processor 110, which when executed by processor 110, cause processor 110 to execute an embodiment of the present invention. Also, aspects of the present invention may be embodied in data stored on a machine-readable medium, where the data represents a design or other information usable to fabricate all or part of processor 110.

Thus, embodiments of an invention for measuring applications loaded in secure enclaves at runtime have been described. While certain embodiments have been described, and shown in the accompanying drawings, it is to be understood that such embodiments are merely illustrative and not restrictive of the broad invention, and that this invention not be limited to the specific constructions and arrangements shown and described, since various other modifications may occur to those ordinarily skilled in the art upon studying this disclosure. In an area of technology such as this, where growth is fast and further advancements are not easily foreseen, the disclosed embodiments may be readily modifiable in arrangement and detail as facilitated by enabling technological advancements without departing from the principles of the present disclosure or the scope of the accompanying claims.

What is claimed is:

1. A processor comprising:
an instruction unit to receive an instruction to extend a first measurement of a secure enclave with a second measurement; and
an execution unit to execute the instruction after initialization of the secure enclave.

2. The processor of claim 1, wherein execution of the instruction includes calculating a hash value based on a concatenation of the first measurement and the second measurement.

3. The processor of claim 2, further including a measurement unit to calculate the hash value.

4. The processor of claim 2, further comprising an enclave page cache having a measurement register in which to store the hash value.

5. The processor of claim 4, wherein execution of the instruction also includes storing the hash value in the measurement register to replace one of the first measurement and the second measurement.

6. The processor of claim 2, further comprising an encryption unit to derive a key based on the hash value.

7. A method comprising:
receiving an instruction to extend a first measurement of a secure enclave with a second measurement; and
executing the instruction after initialization of the secure enclave.

8. The method of claim 7, further comprising generating the first measurement before initialization of the secure enclave.

9. The method of claim 8, wherein the first measurement is based on a first application.

10. The method of claim 9, wherein the second measurement is based on a second application.

11. The method of claim 10, wherein the first application is loaded into the secure enclave before initialization of the secure enclave.

12. The method of claim 11, wherein the second application is loaded into the secure enclave after initialization of the secure enclave.

13. The method of claim 12, wherein execution of the instruction includes calculating a hash value based on a concatenation of the first measurement and the second measurement.

14. The method of claim 13, further comprising storing the hash value in a measurement register in an enclave page cache.

15. The method of claim 14, further wherein storing the hash value in the measurement register includes replacing one of the first measurement and the second measurement.

16. The method of claim 15, further comprising deriving a key based on the hash value.

17. The method of claim 16, further comprising using the key to attest to the identity of the secure enclave as configured with the second application at runtime.

18. The method of claim 7, wherein executing the instruction is performed from within the secure enclave.

19. The method of claim 7, wherein executing the instruction is performed from outside the secure enclave.

20. A system comprising:
a memory; and
a processor including
an instruction unit to receive an instruction to extend a first measurement of a secure enclave with a second measurement, and
an execution unit to execute the instruction after initialization of the secure enclave.
